(19) United States
(12) Patent Application Publication
(10) Pub. No.: US 2026/0214477 A1
(43) Pub. Date: Jul. 23, 2026

(54) Identifying Anomalies in Communication Networks Using Bi-Level Decentralized Machine Learning Model

(71) Applicant: Telefonaktiebolaget LM Ericsson (publ), Stockholm (SE)

(72) Inventors: Tahar ZANOUDA, SOLNA (SE); Rémi BOURGERIE, Stockholm (SE); Dominik BUDYN, Dobczyce (PL)

(73) Assignee: Telefonaktiebolaget LM Ericsson (publ), Stockholm (SE)

(21) Appl. No.: 19/143,019

(22) PCT Filed: Jul. 30, 2023
(86) PCT No.: PCT/EP2023/052107

§ 371 Date: Jun. 25, 2025

(51) Int. Cl. H04W 24/08; H04L 41/16; H04W 24/04

(52) U.S. Cl. CPC H04W 24/08; H04L 41/16; H04W 24/04

(57) ABSTRACT

A computer-implemented method performed by a computing device is provided to identify anomalies in a communication network subsequent to deployment of a computer program comprising program code. The method includes evaluating performance of the communication network with a bi-level decentralized machine learning, ML, model to identify anomalies in the communication network. The bi-level decentralized ML model includes a temporal graph-based ML model that includes an execution flow of the program code and combines knowledge from a plurality of cells in the communication network that respectively execute the program code. The method further includes, based on the evaluating, identifying an anomaly in the communication network.

### TECHNICAL FIELD

The present disclosure relates generally to a computer-implemented method performed by a computing device to identify anomalies in a communication network subsequent to deployment of a computer program comprising program code.

### BACKGROUND

In today's connected world, mobile operators across the globe are constantly rolling out new software (SW) offerings and tuning software configurations to meet evolving user requirements. Despite many efforts to mitigate issues in networks, an operational network can experience problems due to evolving network usage and rising complexity of telecommunications technologies. This challenge can force telecommunications companies to dedicate human efforts towards assessing new SW offerings to identify emerging faults in the network.

Mobile operators can introduce SW upgrades in a form of new SW releases, or new SW feature activations to enhance quality of service, adapt to environmental change, or improve SW performance, for example. Before rolling out a SW release in the network, the SW release typically goes through a rigorous testing process in a controlled environment (e.g., testbed).

In an attempt to prevent SW change abnormalities, mobile operators usually conduct field trials on a small scale in the field, sometimes referred to as a CD Zone, to identify faults and problems in operational networks of new SW capabilities.

### SUMMARY

There currently exist certain challenge(s). In an attempt to prevent SW change abnormalities, telecommunications SW/hardware (HW) vendors, for example, may implement monitoring capabilities in a site. As a consequence, data generated by each site gets bigger. With the rise of data generated in each site, the cost of transferring data to the cloud and storing it in a central data storage can be high, and in some cases may not be possible. Moreover, new data privacy regulations have tightened possibilities to move and store data across geographic regions. Telecommunications networks, for example, are distributed and telecommunications data can be sensitive. In addition, portions of site data may be encrypted.

Certain aspects of the disclosure and their embodiments may provide solutions to these or other challenges.

A computer-implemented method performed by a computing device is provided to identify anomalies in a communication network subsequent to deployment of a computer program comprising program code. The method includes evaluating performance of the communication network with a bi-level decentralized machine learning, ML, model to identify anomalies in the communication network. The bi-level decentralized ML model includes a temporal graph-based ML model that includes an execution flow of the program code and combines knowledge from a plurality of cells in the communication network that respectively execute the program code. The method further includes, based on the evaluating, identifying an anomaly in the communication network.

In some embodiments, the method further includes preparing the temporal graph-based ML model. The preparing includes (i) accessing data for respective cells from the plurality of cells, (ii) building a first graph comprising an execution flow graph of the program code using software events, and (iii) building a second graph comprising a network graph using the knowledge comprising relations between cells in the plurality of cells. The method further includes training the bi-level decentralized ML model comprising the temporal graph-based ML model that includes the execution flow of the program code represented by the first graph and combines the knowledge from the plurality of cells represented by the second graph.

In some embodiments, the identifying an anomaly in the communication network includes using the bi-level decentralized ML model to locate an anomaly in the communication network based on an evaluation criteria.

In some embodiments, the method further includes collecting the data for the respective cells from the plurality of cells. The data includes (i) cell configuration data comprising attributes of the respective cells, relations among cells from the plurality of cells, a deployment setup of the respective cells, and an operating condition of the respective cells, and (ii) software performance metrics for the execution flow of the program code.

In some embodiments, the software performance metrics for the first graph comprising the execution flow graph of the of the program code includes (i) connection of performance management counters, or (ii) connection of procedure-level data.

In some embodiments, the second graph includes a representation of the plurality of cells in the communication network and the representation includes (i) a plurality of nodes that represent the plurality of cells and a plurality of cell features, and (ii) a plurality of edges connecting each cell with a neighboring cell from the plurality of cells in the communication network.

In some embodiments, training the bi-level decentralized ML model includes (i) iteratively performing a plurality of decentralized learning rounds based on a training strategy decided by the computing device. The decentralized learning rounds of respective cells from the plurality of cells decide on a respective local training strategy using respective local data.

In some embodiments, the iterative performance of decentralized machine learning includes selecting, based on a first rule, at least a first subset of cells from the plurality of cells to perform local training of the bi-level temporal graph-based ML model; broadcasting the temporal graph-based ML model to the at least first subset of cells; receiving local update parameters from the at least first subset of cells; updating a global parameter of the temporal graph-based ML model based on a second rule using at least a second subset of the cells from the at least first subset of cells; and deciding whether to perform another decentralized learning round based on whether a convergence criteria is satisfied.

In some embodiments, the first rule includes a cell selection rule including criteria for selecting one of the plurality of cells or a portion of the plurality of cells represented in the temporal graph-based ML model.

In some embodiments, the second rule includes an aggregation rule to select at least the second subset of the cells from the cells represented in the temporal graph-based ML model.

In some embodiments, the convergence criteria includes at least one metric from a performance management data of the communication network.

In some embodiments, the method further includes deploying the temporal graph-based ML model at the plurality of cells.

In some embodiments, the temporal graph-based ML model includes a graph neural network (GNN) model.

In some embodiments, the computing device is a cloud-based computing device.

In other embodiments, a computing device is provided. The computing device is configured to identify anomalies in a communication network subsequent to deployment of a first computer program comprising first program code. The computing device includes processing circuitry; and memory coupled with the processing circuitry. The memory includes instructions that when executed by the processing circuitry causes the computing device to perform operations. The operations include to evaluate performance of the communication network with a bi-level decentralized ML model to identify anomalies in the communication network. The bi-level decentralized ML model includes a temporal graph-based ML model that includes an execution flow of the program code and combines knowledge from a plurality of cells in the communication network that respectively execute the program code. The operations further include, based on the evaluation, to identify an anomaly in the communication network.

In yet other embodiments, a computing device is provided that is configured to identify anomalies in a communication network subsequent to deployment of a first computer program comprising first program code. The computing device is adapted to perform operations. The operations include to evaluate performance of the communication network with a bi-level decentralized ML model to identify anomalies in the communication network. The bi-level decentralized ML model includes a temporal graph-based ML model that includes an execution flow of the program code and combines knowledge from a plurality of cells in the communication network that respectively execute the program code. The operations further include, based on the evaluation, to identify an anomaly in the communication network.

In other embodiments, a computer program product is provided comprising a non-transitory storage medium including second program code to be executed by processing circuitry of a computing device configured to identify anomalies in a communication network subsequent to deployment of a first computer program comprising first program code. Execution of the second program code causes the computing device to perform operations. The operations include to evaluate performance of the communication network with a bi-level decentralized ML model to identify anomalies in the communication network. The bi-level decentralized ML model includes a temporal graph-based ML model that includes an execution flow of the program code and combines knowledge from a plurality of cells in the communication network that respectively execute the program code. The operations further include, based on the evaluation, to identify an anomaly in the communication network.

In other embodiments, a second computer program is provided comprising second program code to be executed by processing circuitry of a computing device configured to identify anomalies in a communication network subsequent to deployment of a first computer program comprising first program code. Execution of the second program code causes the computing device to perform operations. The operations include to evaluate performance of the communication network with a bi-level decentralized ML model to identify anomalies in the communication network. The bi-level decentralized ML model includes a temporal graph-based ML model that includes an execution flow of the program code and combines knowledge from a plurality of cells in the communication network that respectively execute the program code. The operations further include, based on the evaluation, to identify an anomaly in the communication network.

Certain embodiments may provide one or more of the following technical advantage(s). A bi-level decentralized ML model can be exposed to diverse deployment scenarios and configuration settings in a privacy-preserving manner. Moreover, based on an evaluation of performance of the communication network with the bi-level decentralized ML model to identify anomalies in the communication network an evaluation, challenges associated with assessing the program code (e.g., SW) in multiple operational customer networks may be solved. For example, when assessing behavior of a telecommunications SW operational network, each customer can test the same SW from the same telecom vendor separately. As a consequence, mobile operations may benefit from the evaluation of a same new SW in diverse configuration and network usage scenarios while preserving privacy.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1A is a diagram illustrating an example of a network level hierarchical structure for use in decentralized learning to learn faulty patterns from different nodes in accordance with some embodiments;

FIG. 1B is a diagram illustrating an example of a SW level hierarchical structure for use in decentralized learning to learn faulty patterns from the different nodes of FIG. 1A in accordance with some embodiments;

FIGS. 2A and 2B are a context establishment graph illustrating an example of how performance management (PM) counters can be structured in a hierarchical way in accordance with some embodiments;

FIG. 3 is a graph illustrating an example of how procedure-level events are connected and can be structured in a hierarchical way in accordance with some embodiments;

FIG. 4 is a flow chart illustrating building a first graph in accordance with some embodiments;

FIG. 5 is a diagram illustrating a temporal GNN based ML model in accordance with some embodiments;

FIG. 6 is a flow chart illustrating operations of an example of the present disclosure;

FIG. 7 is a flow chart illustrating operations of a computing device in accordance with some embodiments;

FIG. 8 includes an example of results for anomaly identification based on events from FIG. 3;

FIG. 9 is a block diagram illustrating a cloud computing environment communicatively coupled to a communication network in accordance with some embodiments; and

FIG. 10 is a block diagram illustrating a computing device in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of the present disclosure are shown. Inventive concepts may, however, be embodied in many different forms and should not be construed as limited to the embodiments set forth herein. Rather, these embodiments are provided so that this disclosure will be thorough and complete, and will fully convey the scope of the present disclosure to those skilled in the art. It should also be noted that these embodiments are not mutually exclusive. Components from one embodiment may be tacitly assumed to be present/used in another embodiment.

As previously discussed, despite efforts to mitigate issues in networks from SW, an operational network can experience problems due to evolving network usage and rising complexity of telecommunications technologies. This challenge can force telecommunications companies to dedicate human efforts towards identifying SW issues, which may be a burden for telecommunications companies.

While, before rolling out a SW release in the network, the SW release typically goes through a rigorous testing process in a controlled environment (e.g., testbed), such testing may have drawbacks. For example, a network can experience a problem due to unseen environmental conditions that can be hard to simulate in a testing environment.

While assessing SW performance in a CD Zone is performed in real-world settings, a small number of sites for each operator network can constrain the diversity of testing scenarios for new SW.

Some approaches may be devoted to monitoring network performance. Such approaches, however, may be time-consuming; and monitoring a communication network (e.g., a telecommunication network) to detect anomalies in a timely manner may be lacking. With advanced artificial intelligence (AI) techniques, while it may be possible to optimize and simplify some network diagnostics processes, telecommunications networks are distributed and telecommunications data can be sensitive, which presents a challenge for mobile operators to leverage traditional centralized machine learning (ML) techniques.

Decentralized machine learning techniques can be used for highly distributed data to be mined in a privacy-preserving manner across different geographic regions, and across networks of different operators that try to evaluate the same SW. Decentralized machine learning may allow the telecommunications industry to harness isolated data to enable collaborative model training and learn failure patterns without the need to share the raw data.

There currently exist certain challenge(s). As previously discussed, in an attempt to prevent SW change abnormalities, telecommunications SW/HW vendors, for example, may implement monitoring capabilities in a site. As a consequence, data generated by each site gets bigger. With the rise of data generated in each site, the cost of transferring data to the cloud and storing it in a central data storage can be high, and in some cases may not be possible. Moreover, new data privacy regulations have tightened possibilities to move and store data across geographic regions. Telecommunications networks, for example, are distributed and telecommunications data can be sensitive. In addition, portions of site data may be encrypted.

A telecom network includes a set of interconnected nodes located in distributed geographical regions across an area (e.g. across a city). Each cell in a site provides coverage in a geographic area, which may be referred to as a sector coverage area. The sector, or a coverage area, can have distinctive characteristics such as socio-demographic characteristics of network users and topographic factors of coverage region.

Mobile operators typically monitor the performance of a telecom network after deploying the telecom network to mitigate network failures or avoid performance degradation, for example. Such problems in the deployed network usually may be a result of network usage changes. Therefore, the cells serving certain geographical areas in a city, for example, can be configured in a way to maximize coverage. Moreover, each sector can have its own built-up infrastructure, socio-demographic network usage, and topographic characteristics that can trigger different anomalies in the network. Thus, there may be a need to expose SW to myriad deployment scenarios regardless of the operator.

The deployment of Fifth generation (5G) networks and beyond are envisioned to be dense, this latter may exacerbate the need to expose SW to myriad deployment scenarios regardless of the operator.

Certain aspects of the disclosure and their embodiments may provide solutions to these or other challenges. The present disclosure is directed to identifying and localizing anomalies (such as faults, for example) for SW offerings deployed in a communication network (e.g., in a telecommunication network). Operations of the present disclosure leverage the hierarchical structure of SW performance, and train fault detection models using a graph-based decentralized machine learning approach.

Examples of the present disclosure leverage decentralized machine learning (e.g., federated learning) to combine knowledge from different nodes in the network. A decentralized model can be exposed to diverse deployment scenarios and configuration settings in a privacy-preserving manner. Certain examples of the present disclosure leverage temporal GNNs to characterize and model node performance temporal behavior

Certain examples include modeling a telecom SW execution flow as a temporal GNN; and developing a multivariate unsupervised anomaly detection model using a temporal GNN-based decentralized machine learning architecture to identify faults in telecom SW deployed in a telecom network.

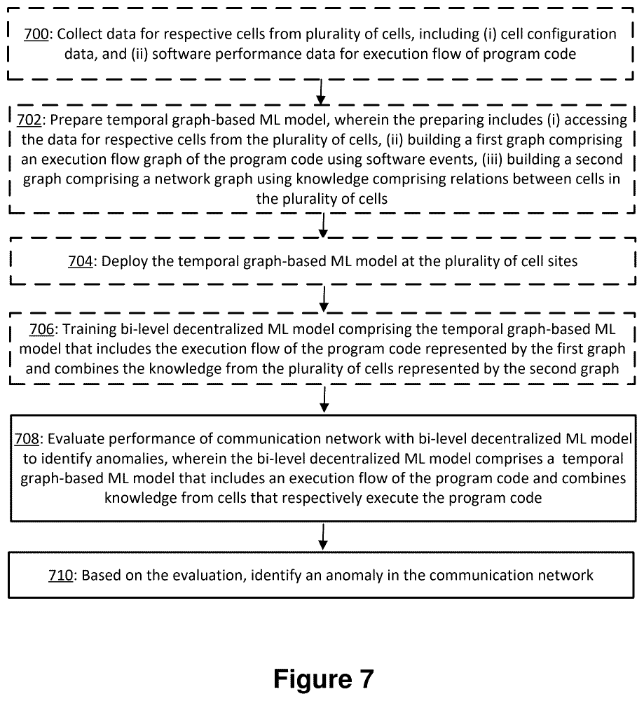

As illustrated in FIG. 7, a computer-implemented method performed by a computing device is provided to identify anomalies in a communication network subsequent to deployment of a computer program comprising program code. The method includes evaluating (708) performance of the communication network with a bi-level decentralized ML model to identify anomalies in the communication network. The bi-level decentralized ML model includes a temporal graph-based ML model that includes an execution flow of the program code and combines knowledge from a plurality of cells in the communication network that respectively execute the program code. The method further includes, based on the evaluating, identifying (710) an anomaly in the communication network.

Certain embodiments may provide one or more of the following technical advantage(s). Based on leveraging decentralized machine learning, knowledge from different nodes in an operational communication network across different operators can be combined. As a consequence, the bi-level decentralized ML model can be exposed to diverse deployment scenarios and configuration settings in a privacy-preserving manner. Moreover, based on the evaluation, challenges associated with assessing the program code (e.g., SW) in multiple operational customer networks may be solved. For example, when assessing behavior of a telecommunications (“telecom”) SW operational network, each customer can test the same SW from the same telecom vendor separately. As a consequence, the mobile operations may benefit from the evaluation of a same new SW in diverse configuration and network usage scenarios while preserving privacy.

Moreover, examples of the present disclosure may address some of the aforementioned challenges associated with assessing SW in multiple operational customer networks and detecting faults in operational networks. When rolling out a SW, each customer can monitor the same SW from the same telecom vendor separately based on use of a bi-level decentralized machine learning approach to train an unsupervised anomaly detection ML model. Examples of the present disclosure leverage the structural execution of SW (e.g., program code) and model the structural execution of the SW using a temporal GNN, for example, and then uses network topology to capture network relationships. As a consequence, mobile operations may benefit from the evaluation of the same SW in diverse configuration and network usage scenarios while preserving privacy.

For example, in some embodiments, the method further includes preparing (702) the temporal graph-based ML model. The preparing (702) includes (i) accessing data for respective cells from the plurality of cells, (ii) building a first graph comprising an execution flow graph of the program code using software events, and (iii) building a second graph comprising a network graph using the knowledge comprising relations between cells in the plurality of cells. The method further includes training (706) the bi-level decentralized ML model comprising the temporal graph-based ML model that includes the execution flow of the program code represented by the first graph and combines the knowledge from the plurality of cells represented by the second graph.

In some embodiments, identifying (710) an anomaly in the communication network includes using the bi-level decentralized ML model to locate an anomaly in the communication network based on an evaluation criteria.

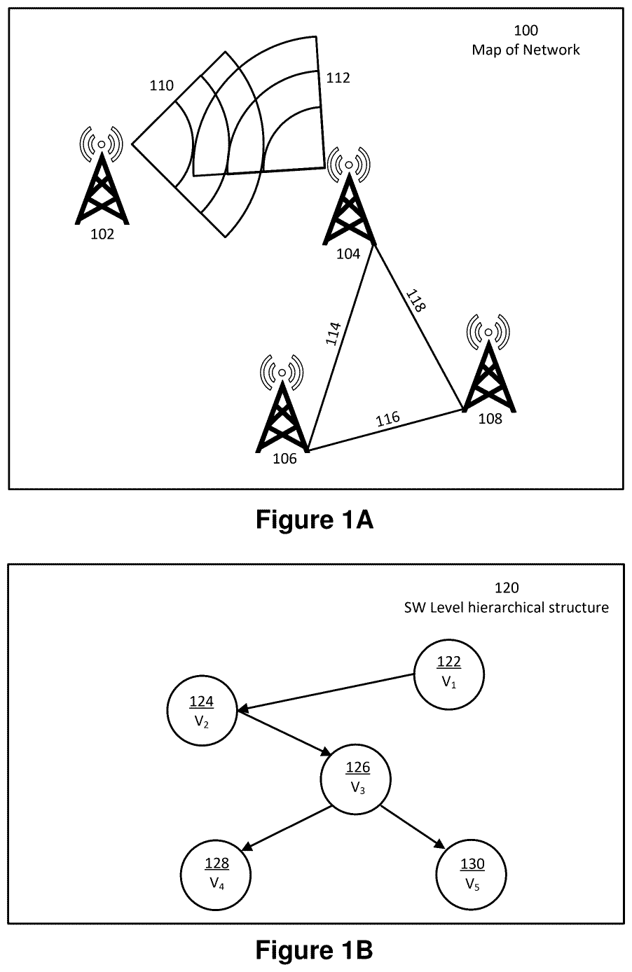

FIG. 1A is a diagram illustrating a map 100 showing an example of a network level hierarchical structure for use in decentralized machine learning to learn faulty patterns from different nodes 102, 104, 106, 108 (e.g., base stations) in accordance with some embodiments. In this example, the communication network includes the depicted set of interconnected sites located in distributed geographical regions. Each cell in a site provides coverage in a geographic area, which also can be referred to as a cell coverage area. A site can include different cells, each cell can have different configuration parameters. Further, in this example, each cell is running a same SW, and the SW proceeds through the same operations in each cell.

FIG. 1B is a diagram illustrating an example of a SW level hierarchical structure 120 for use in decentralized machine learning to learn faulty patterns from the different nodes of FIG. 1A in accordance with some embodiments. SW level hierarchical structure 120 includes a SW execution flow of event names V₁ 122; V₂ 124; V₃ 126; V₄ 128; and V₅ 130.

Operations of some examples of the present disclosure include the following: (i) data collection; (ii) a temporal graph-based architecture; and (iii) a decentralized temporal graph-based ML model.

Regarding data collection, in some examples, data is collected. The collected data can be grouped in two categories: (1) Cell configuration data, and (2) SW performance metrics.

For example, in some embodiments, the method further includes collecting (700) the data for the respective cells from the plurality of cells. The data includes (i) cell configuration data comprising attributes of the respective cells, relations among cells from the plurality of cells, a deployment setup of the respective cells, and an operating condition of the respective cells, and (ii) software performance metrics for the execution flow of the program code. An operating condition can include a cell(s) put on sleep mode, or deactivated.

Regarding cell configuration data, the following table shows a non-exhaustive list of some example site/cell attributes. It is noted that one base station can be associated with different cells.

Site/Cell Attribute Name

Data collection time
Site ID
Global Cell ID
Cell parameters
Frequency/Frequencies
. . .
SW version

SW performance metrics, in some examples, can include two types of metrics collected in a node (1) performance management (PM) counters, and (2) procedure level time-series data. Each type of metric one can be represented as a time-series graph. Examples of the present disclosure can use any such metrics that can be modeled as a time-series graph network.

For example, in some embodiments, the SW performance metrics for the first graph comprising the execution flow graph of the of the program code includes (i) connection of performance counters, or (ii) connection of procedure-level data.

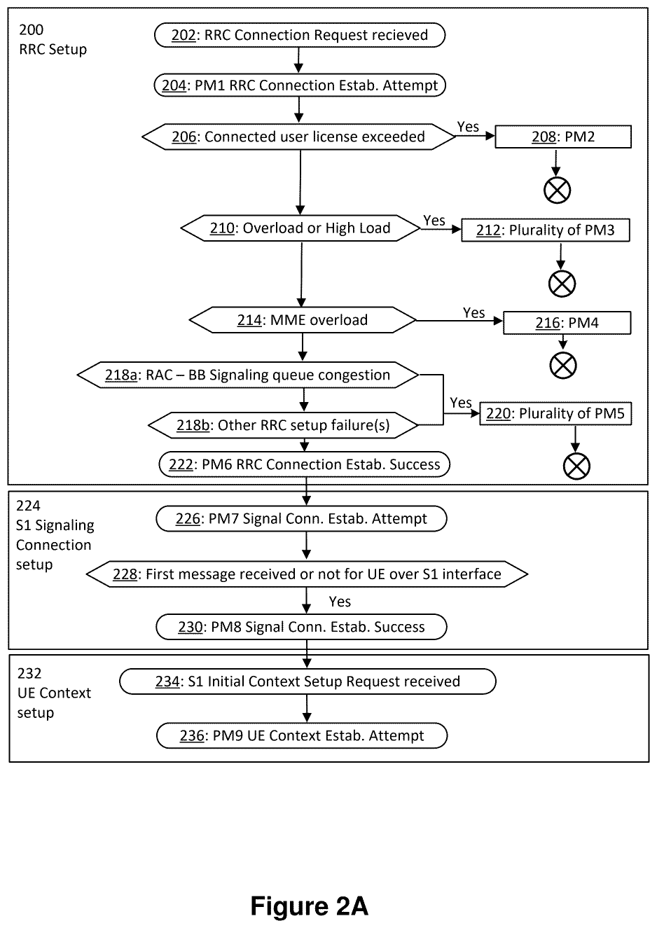

PM data of the network may be used to gauge network performance. PM data (e.g., PM counters) may be captured at regular intervals across network sites. PM data can also be represented in hierarchical way. FIGS. 2A and 2B is a context establishment graph illustrating an example of how PM counters can be structured in a hierarchical way in accordance with some embodiments. As shown in FIGS. 2A and 2B, context establishment is structured in a hierarchical way that includes radio resource control (RRC) Setup 200+S1 Connection Setup 224+UE Context Setup 232. UE context setup 232 includes operations 234, 236, and security mode setup 238, optional capability inquiry 246 and RRC reconfiguration 258, and operations 270 and 272. The PM counters of FIGS. 2A and 2B can be collected by mobile operators and SW vendors.

RRC setup 200 includes operations 202-222. In operation 202, a RRC connection request is received. A first PM 1 includes, in operation 204, an RRC connection establishment attempt. Operation 206 include a determination whether a connected user license is exceeded. If yes, operations proceed to operation 208 which indicates a second PM 2 that the connected user license is exceeded. If no, operations proceed to operation 210 for a determination of whether there is an overload or a high load. If yes, operations proceed to operation 212 which indicates a third PM 3 (or plurality of PMs) that there is an overload or high load. If no, operations proceed to operation 214 to determine whether there is a MME overload. If yes, operations proceed to operation 216 which indicates a fourth PM 4 that there is a MME overload. If no, operations proceed to operations 218a/218b to determine whether there is another failure case(s) for RRC Setup (e.g., such as a RRC connection setup timeout). If yes, operations proceed to operation 220 which indicates a PM 5 (or a plurality of PM 5) that there is a failure for RRC Setup. If no, operations proceed to operation 222 which indicates a PM 6 that a successful RRC connection is established.

S1 Connection Setup 224 includes operation 226-230. In operation 226, a seventh PM 7 indicates a signalling of a connection establishment attempt. Operation 228 determines whether a first message is received or not for a user equipment (UE) over an S1 interface. If yes, operations proceed to operation 230 which indicates an eighth PM 8 that a successful signal connection is established.

UE Context Setup 232 begins with operation 234 indicating that an S1 initial context setup request was received. In operation 236, a ninth PM 9 indicates a UE context establish attempt.

Security mode setup 238 of UE context setup includes operations 240-244. Operation 240 sends a RRC security mode command. Operation 242 determines whether the security setup was successful. If no, operations stop. If yes, operations proceed to operation 244. Operation 244 includes receiving an indication that RRC security mode is complete.

Optional capability inquiry 246 includes operation 248-256. Operation 248 determines whether a capability inquiry is needed. If yes, operations proceed to operation 250 to send a UE capability inquiry. Operation 252 determines whether the US capability inquiry was successful. If no, operations end. If yes, operations proceed to operations 254 which receives the UE capability information. Operation 256 is a point (also referred to herein as a “junction”) where the two execution paths shown in optional capability inquiry 246 merge. That is, capability inquiry 246 is optional and for a case where capability inquiry 246 is not needed, operations proceed directly from operation 248 to junction 256.

Optional RRC reconfiguration 258 includes operations 260-268. Operation 260 sends a RRC connection reconfiguration. Operation 262 determines a tenth PM 10 that indicates the RRC connection reconfiguration. Operation 264 determines whether the RRC reconfiguration is successful. If no, operations end. If yes, operations proceed to operation 266 to receive an indication that RRC connection reconfiguration is complete. Operations proceed to operation 268, which indicates an eleventh PM 11 for the complete RRC connection reconfiguration.

The hierarchical structure of the UE Context Setup 232 ends with operations 270 and 272. Operation 270 sends an S1 initial context setup response. Operation 272 indicates a twelfth PM 12 that indicates that the UE context setup is established.

Regarding procedure level time-series data, procedure level time-series data may provide more detailed information about a root cause of an anomaly (which may include a failure, for example) than other observability data points for a number of reasons. Unlike PM counters, procedure level time series data may be defined, for example, as internal information that is not exposed to customers and it is often used for SW troubleshooting.

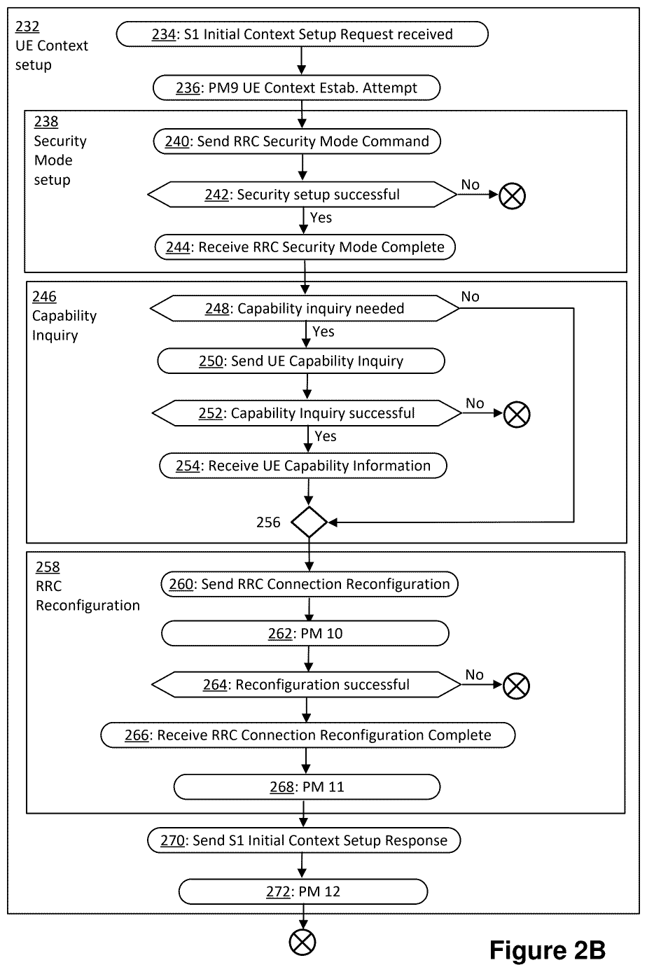

FIG. 3 is a graph illustrating an example of how procedure-level events are connected and can be structured in a hierarchical way in accordance with some embodiments. The graph of FIG. 3 is built using procedure-level data (e.g., knowledge that includes relations between cells in the plurality of cells). Using procedures defined as a sequence of events, as shown in the example in FIG. 3, allows for finding connections between different procedure types that are potentially degraded due to same reason, for example.

In the example of FIG. 3, an RRC setup procedure is shown using more detailed data (that is, procedure-level time series data) collected by SW vendors than the data shown in FIG. 2A for the RRC Setup 200. The more detailed data illustrated in FIG. 3 may provide a finer granularity of analysis than the data of FIG. 2A to support troubleshooting of SW failures, for example.

While FIG. 2A and FIG. 3 show two different data types for a RRC Setup 200, both FIG. 2A and FIG. 3 cover the same SW execution flow for the RRC Setup 200. Both types of data can be used to model SW execution flow using performance metrics. The main difference between the execution flow graphs of FIG. 2A and FIG. 3 for the RRC Setup 200 is in granularity and level of details.

For example, as illustrated in FIG. 2A, the number of PM counters associated with the RRC Setup 200 is far less than the number of than events and/or edges 300-324 associated with the procedure illustrated in FIG. 3. On the other hand, however, using PM counters as illustrated in FIGS. 2A/2B can provide a good structure across different technologies as PM counters often are standardized across different vendors (e.g., 3GPP standards).

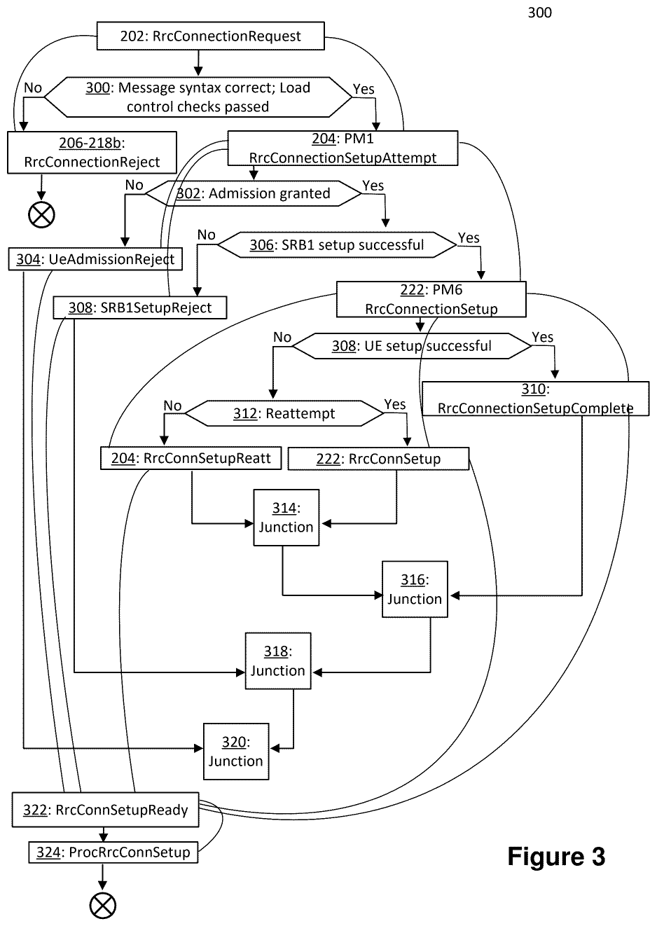

In order to build a temporal graph-based model, in some examples, the SW execution graph (also referred to herein as a “first graph”) can be prepared. SW execution flow can be characterized using a set of interdependency and connected events represented, for example, using an adjacency matrix. Each event can represent a step in the SW execution flow. The event can have a different value over time, representing time-series data points. FIG. 4 shows example operations for building the graph, and generating adjacency matrix. In operation 400, performance time series data is obtained relating to execution of SW. In operation 402, the performance of time-series data of telecom SW can be represented as a temporal graph G=(V,E) with n nodes that represent events and d dimensional features X∈R^{n*d}. The graph includes nodes V (event names) that are connected with edges E represented as execution flow between two events. It is noted, however, that while an edge can connect two events, a plurality of edges can represent the execution flow and can connect several events and represent the hierarchical structure of the events.

Nodes in a SW execution graph can be represented by events, where each event is characterized using a value count and type of event. Each temporal graph based model can capture SW execution flow inside each site.

In some embodiments, the second graph includes a representation of the plurality of cells in the communication network and the representation includes (i) a plurality of nodes that represent the plurality of cells and a plurality of cell features, and (ii) a plurality of edges connecting each cell with a neighboring cell from the plurality of cells in the communication network.

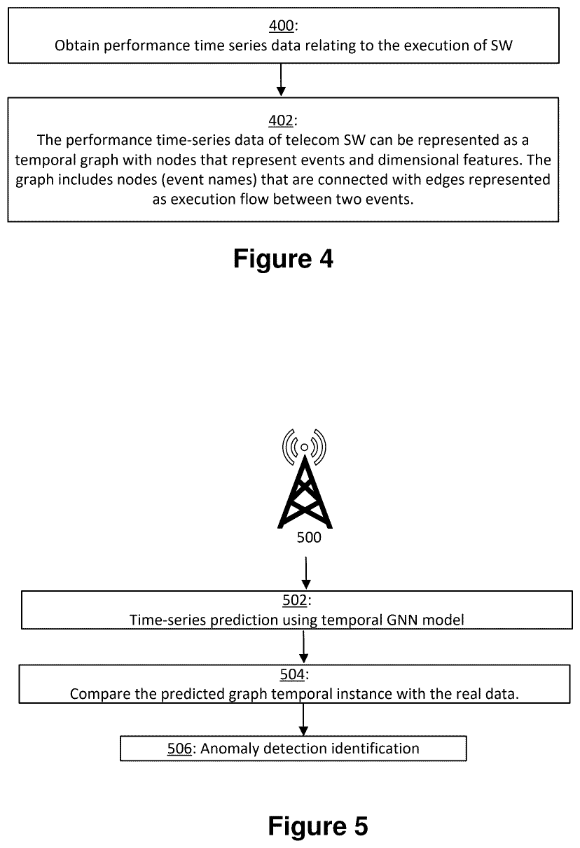

FIG. 5 is a diagram illustrating a temporal graph-based ML model in accordance with some embodiments. As illustrated in FIG. 5, anomaly detection operations can include: (1) time-series prediction 502 using a temporal GNN model; (2) comparing 504 the predicted graph temporal instance with real data; and (3) anomaly detection identification 506. Regarding temporal GNN prediction 502, a prediction ML model can be built using a temporal GNN architecture to predict the next instance of a graph temporal instance. Regarding anomaly detection identification 506, the predicted graph temporal instance can be compared with real data in operation 504. An outlier detection distance metric can be used in operation 506 to label a graph temporal instance as anomalous or not.

The bi-level decentralized ML model (e.g., a federated GNN Model) is now further discussed. Decentralized machine learning (e.g., federated learning (FL)) can be referred to as a collaborative learning scheme among multiple clients, where the model parameters from local ML models are shared and aggregated under the supervision of a central server without sharing local training data. See e.g., Liu, Rui, and Han Yu. “Federated Graph Neural Networks: Overview, Techniques and Challenges.” arXiv preprint arXiv:2202.07256 (2022).

A temporal graph-based architecture of examples described herein can be retained as a local ML model architecture for each node in a customer network, as well as for a central server ML model. Local data can represent the dataset obtained by each customer site. The central server can decide on a decentralized training strategy (e.g., a FL training strategy). Customer nodes can decide on their local training strategy.

In some embodiments, for example, training the bi-level decentralized ML model includes (i) iteratively performing a plurality of decentralized learning rounds based on a training strategy decided by the computing device. The decentralized learning rounds of respective cells from the plurality of cells decide on a respective local training strategy using respective local data.

The iterative performance of decentralized learning can include selecting, based on a first rule, at least a first subset of cells from the plurality of cells to perform local training of the bi-level temporal graph-based ML model; broadcasting the temporal graph-based ML model to at least first subset of cells; receiving local update parameters from the at least first subset of cells; updating a global parameter of the temporal graph-based ML model based on a second rule using at least a second subset of the cells from the at least first subset of cells; and deciding whether to perform another decentralized learning round based on whether a convergence criteria is satisfied.

The first rule can include a cell selection rule including criteria for selecting one of the plurality of cells or a portion of the plurality of cells represented in the temporal graph-based ML model.

The second rule can include an aggregation rule to select at least the second subset of the cells from the cells represented in the temporal graph-based ML model.

The convergence criteria can include at least one metric from a performance management data of the communication network.

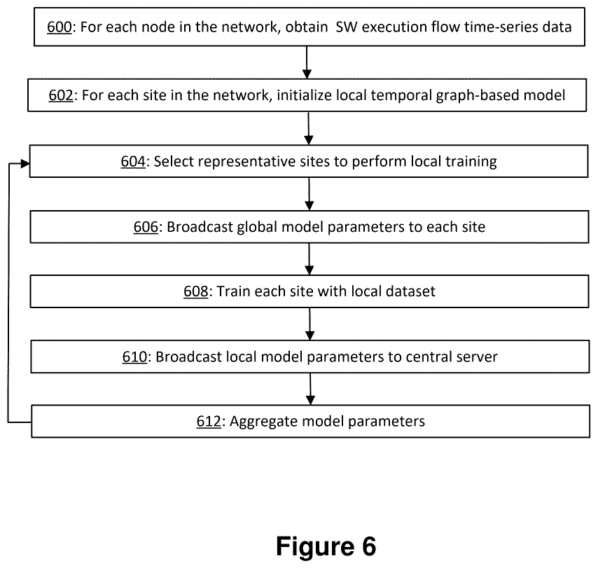

FIG. 6 is a flow chart illustrating operations of a training process of examples of the present disclosure.

After a data loading 600 and model initialization 602 phase, multiple decentralized learning rounds can be performed iteratively based on the central server strategy. Data loading 600 includes, for each node in a communication network, obtaining SW execution flow time-series data. Model initialization 602 includes, for each site in the communication network, initializing a local temporal graph based model. A decentralized learning round can then be performed. Example operations of a decentralized learning round include the following:
Step 1: Client/site selection 604: The sites involved in the update round to perform local training are chosen by the central server based on a client selection rule.
Step 2: Parameter broadcasting 606: The central server broadcasts the global ML model parameters to the selected clients/sites.
Step 3: Local ML model training 608: Clients/sites train local ML models on their respective local data. A temporal GNN model, for example, is trained using a local dataset, where the data is generated on an edge.
Step 4: Personalized ML model aggregation 610: The clients/sites send back local updates parameters to the central server, which in turn updates 612 a global parameter based on an aggregation rule using neighboring nodes. The choice of clients/sites that are used in the aggregation 612 is personalized and based on network hierarchy.
Step 5: The central server decides to perform another round until a convergence criteria is met.

In steps 2 and step 3, local data can be trained locally using secure and privacy-preserving techniques to obfuscate the neural parameters produced by each node.

In some embodiments, the method further includes deploying (704) the temporal graph-based ML model at the plurality of cells.

In some embodiments, the temporal graph-based ML model includes a GNN model.

In some embodiments, the computing device is a cloud-based computing device.

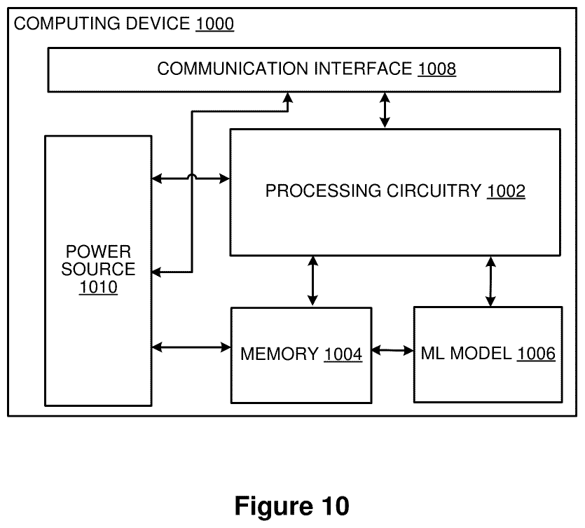

Operations of a computing device can be performed by the computing device 1000 of FIG. 10. Operations of the computing device (implemented using the structure of FIG. 10) have been discussed with reference to the flow chart of FIG. 7 according to some embodiments of the present disclosure. For example, modules may be stored in memory 1004/ML model 1006 of FIG. 10, and these modules may provide instructions so that when the instructions of a module are executed by respective computing device processing circuitry 1002, computing device 1000 performs respective operations of the flow chart.

Various operations from the flow chart of FIG. 7 may be optional with respect to some embodiments of computing devices and related methods. For example, the operations of blocks 700, 702, 704, and 706 may be optional.

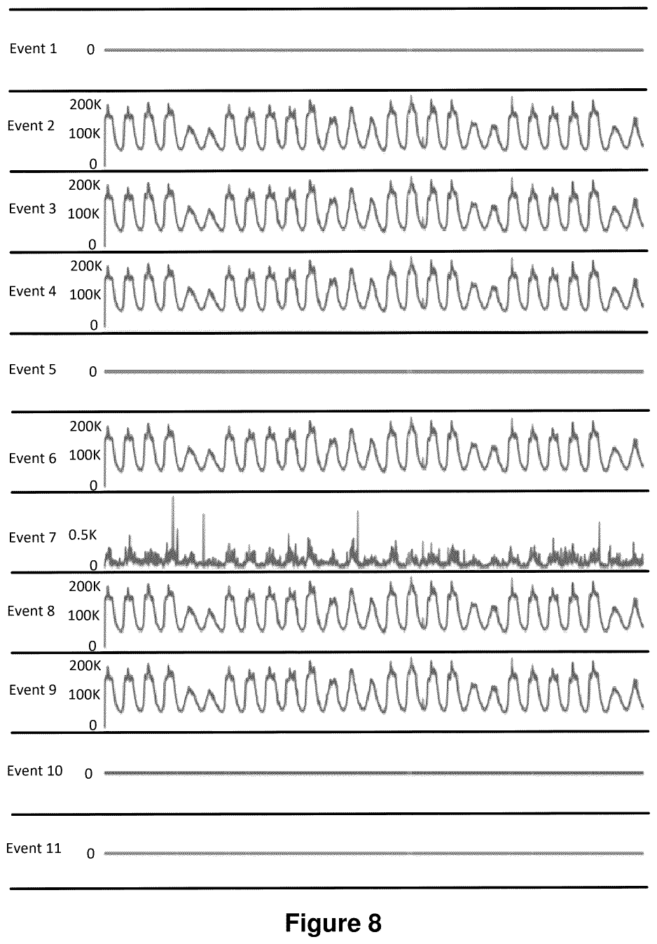

Operations of examples of the present disclosure have been implemented and validated using operational mobile network data. FIG. 8 shows results for one client trained in a FL manner in accordance with certain embodiments herein. The results shown in FIG. 8 show temporal GNN anomaly detection based events from FIG. 3 (that is based on the SW execution graph represented in FIG. 3), and include identified anomalies (e.g., time-outs) at the respective spikes for each of events 2, 3, 4, 6, 7, 8, and 9 from FIG. 3.

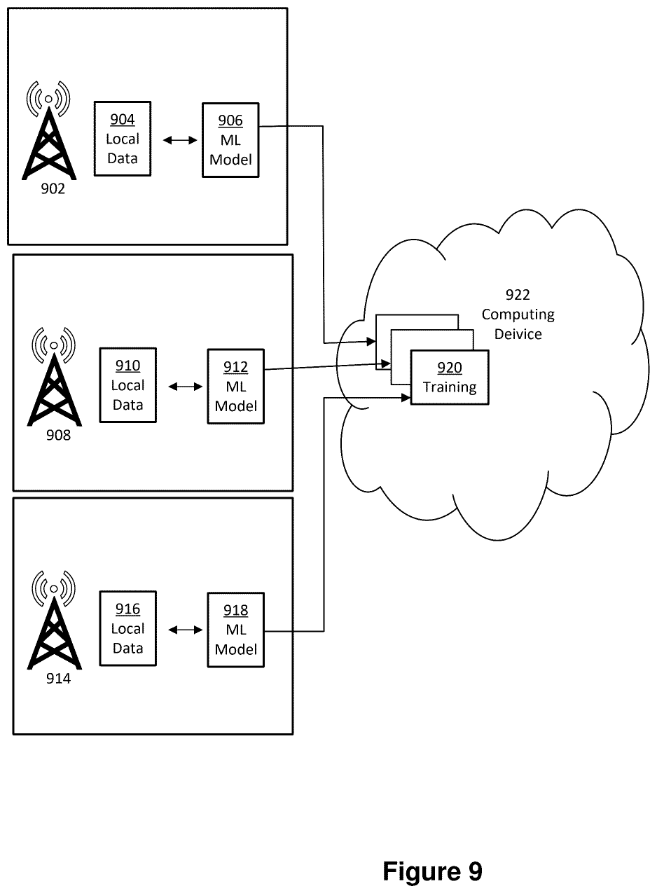

FIG. 9 is a block diagram illustrating a cloud computing environment communicatively coupled to a communication network in accordance with some embodiments. The example of FIG. 9 includes three sites located in distributed geographical regions. Each cell from a base station 902, 908, 914 in a respective site provides coverage in a respective geographic region (also referred to herein as a cell coverage area). Each of the three respective sites can include different cells, and each cell can have different configuration parameters. While FIG. 9 illustrates three sites, operations of the present disclosure are not limited to three sites. Rather, any number of a plurality of sites is included.

As shown in the example of FIG. 9, training 910 a bi-level decentralized ML model of cloud-based computing device 922 includes iteratively performing a plurality of decentralized learning rounds based on a training strategy decided by the computing device 922. The decentralized learning rounds of respective cells from the plurality of cells of the three sites decide on a respective local training strategy using respective local data 904, 910, 916. Cloud-based computing device 922 may be an embodiment of the computing device in accordance with some embodiments described herein. The computing device 922 may be or comprise various combinations of HW and/or SW, including a standalone server, a blade server, a cloud-implemented server, a distributed server, a virtual machine, container, or processing resources in a server farm.

FIG. 10 is a block diagram illustrating a computing device in accordance with some embodiments. The computing device 1000 includes processing circuitry 1002 that is operatively coupled to memory 1004, ML model 1006, communication interface 1008, power source 1010 306, and/or any other component, or any combination thereof. Certain computing devices may utilize all or a subset of the components shown in FIG. 10. The level of integration between the components may vary from one computing device to another computing device. Further, certain computer devices may contain multiple instances of a component, such as multiple processors, memories, ML models, etc.

The processing circuitry 1002 is configured to process instructions and data and may be configured to implement any sequential state machine operative to execute instructions stored as machine-readable computer programs in the memory 1004 and/or the ML model 1006. The processing circuitry 1002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1304 may include multiple central processing units (CPUs).

In the example, the communication interface 1008 may be configured to provide an interface or interfaces to an input device, output device, or one or more input and/or output devices. Examples of an output device include a display, a monitor, a printer, another output device, or any combination thereof. An input device may allow a user to capture information into the computing device 1000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, a force sensor, an optical sensor, a proximity sensor, a biometric sensor, etc., or any combination thereof. An output device may use the same type of interface port as an input device. For example, a Universal Serial Bus (USB) port may be used to provide an input device and an output device.

The memory 1004 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1004 includes one or more application programs, such as an operating system, web browser application, a widget, gadget engine, or other application, and corresponding data. The memory 1004 may store, for use by the computing device 1000, any of a variety of various operating systems or combinations of operating systems.

The memory 1004 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1004 may allow the computing device 1000 to access instructions, application programs and the like, stored on transitory or non-transitory memory media, to off-load data, or to upload data. An article of manufacture, such as one utilizing a communication system may be tangibly embodied as or in the memory 1004, which may be or comprise a device-readable storage medium.

The processing circuitry 1002 may be configured to communicate with a network using the communication interface 1008. The communication interface 1008 may comprise one or more communication subsystems. The communication interface 1008 may include one or more transceivers used to communicate, such as by communicating with one or more remote transceivers of another device capable of wireless communication (e.g., another computing device, edge node, cloud node, etc.). Each transceiver may include a transmitter and/or a receiver appropriate to provide network communications (e.g., optical, electrical, and so forth).

In the illustrated embodiment, communication functions of the communication interface 1008 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

The ML model 1006 may be the bi-level decentralized ML model discussed further herein.

Functions implemented by some embodiments may be virtualized. In the present context, virtualizing means creating virtual versions of apparatuses or computing devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments hosted by one or more of hardware nodes, such as a hardware computing device that operates as an edge node or cloud node. Further, in embodiments the virtual node may be entirely virtualized.

Applications (which may alternatively be called software instances, virtual appliances, network functions, virtual nodes, virtual network functions, etc.), can be run in the virtualization environment to implement some of the features, functions, and/or benefits of some of the embodiments disclosed herein.

Although the computing devices described herein (e.g., computers, servers, clod-based computing devices, etc.) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Although the devices described herein may include the illustrated combination of hardware components, other embodiments may comprise computing devices with different combinations of components. It is to be understood that these devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the device, and/or performing one or more operations based on the obtained information or converted information, and as a result of said processing making a determination. Moreover, while components are depicted as single boxes located within a larger box, or nested within multiple boxes, in practice, devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by a wireless network generally.

Further definitions and embodiments are discussed below.

In the above-description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer-implemented method performed by a computing device to identify anomalies in a communication network subsequent to deployment of a computer program comprising program code, the method comprising:
evaluating performance of the communication network with a bi-level decentralized machine learning, ML, model to identify anomalies in the communication network, wherein the bi-level decentralized ML model comprises a temporal graph-based ML model that includes an execution flow of the program code and combines knowledge from a plurality of cells in the communication network that respectively execute the program code; and
based on the evaluating, identifying an anomaly in the communication network.

2. The method of claim 1, further comprising:
preparing the temporal graph-based ML model, wherein the preparing comprises (i) accessing data for respective cells from the plurality of cells, (ii) building a first graph comprising an execution flow graph of the program code using software events, and (iii) building a second graph comprising a network graph using the knowledge comprising relations between cells in the plurality of cells; and
training the bi-level decentralized ML model comprising the temporal graph-based ML model that includes the execution flow of the program code represented by the first graph and combines the knowledge from the plurality of cells represented by the second graph.

3. The method of claim 1, wherein the identifying an anomaly in the communication network comprises using the bi-level decentralized ML model to locate an anomaly in the communication network based on an evaluation criteria.

4. The method of claim 2, further comprising:
collecting the data for the respective cells from the plurality of cells, the data comprising (i) cell configuration data comprising attributes of the respective cells, relations among cells from the plurality of cells, a deployment setup of the respective cells, and an operating condition of the respective cells, and (ii) software performance metrics for the execution flow of the program code.

5. The method of claim 3, wherein the software performance metrics for the first graph comprising the execution flow graph of the of the program code includes (i) connection of performance counters, or (ii) connection of procedure-level data.

6. The method of claim 2, wherein the second graph comprises a representation of the plurality of cells in the communication network and the representation includes (i) a plurality of nodes that represent the plurality of cells and a plurality of cell features, and (ii) a plurality of edges connecting each cell with a neighboring cell from the plurality of cells in the communication network.

7. The method of claim 1, wherein the training the bi-level decentralized ML model comprises (i) iteratively performing a plurality of decentralized learning rounds based on a training strategy decided by the computing device, wherein the decentralized learning rounds of respective cells from the plurality of cells decide on a respective local training strategy using respective local data.

8. The method of claim 7, wherein the iterative performance of decentralized machine learning comprises:
selecting, based on a first rule, at least a first subset of cells from the plurality of cells to perform local training of the temporal graph-based ML model;
broadcasting the temporal graph-based ML model to the at least first subset of cells;
receiving local update parameters from the at least first subset of cells;
updating a global parameter of the temporal graph-based ML model based on a second rule using at least a second subset of the cells from the at least first subset of cells; and
deciding whether to perform another decentralized learning round based on whether a convergence criteria is satisfied.

9. The method of claim 8, wherein the first rule comprises a cell selection rule comprising criteria for selecting one of the plurality of cells or a portion of the plurality of cells represented in the temporal graph-based ML model.

10. The method of claim 8, wherein the second rule comprises an aggregation rule to select at least the second subset of the cells from the cells represented in the temporal graph-based ML model.

11. The method of claim 8, wherein the convergence criteria comprises at least one metric from a performance management data of the communication network.

12. The method of claim 8, further comprising:
deploying the temporal graph-based ML model at the plurality of cells.

13. The method of claim 1, wherein the temporal graph-based ML model comprises a temporal graph neural network, GNN, model.

14. The method of claim 1, wherein the computing device is a cloud-based computing device.

15. A computing device configured to identify anomalies in a communication network subsequent to deployment of a first computer program comprising first program code, the computing device comprising:
processing circuitry;
memory coupled with the processing circuitry, wherein the memory includes instructions that when executed by the processing circuitry causes the computing device to perform operations comprising:
evaluate performance of the communication network with a bi-level decentralized machine learning, ML, model to identify anomalies in the communication network, wherein the bi-level decentralized ML model comprises a temporal graph-based ML model that includes an execution flow of the program code and combines knowledge from a plurality of cells in the communication network that respectively execute the program code; and
based on the evaluation, identify an anomaly in the communication network.

16. (canceled)

17. (canceled)

18. (canceled)

19. A computer program product comprising a non-transitory storage medium including second program code to be executed by processing circuitry of a computing device configured to identify anomalies in a communication network subsequent to deployment of a first computer program comprising first program code, whereby execution of the second program code causes the computing device to perform operations comprising:
evaluate performance of the communication network with a bi-level decentralized machine learning, ML, model to identify anomalies in the communication network, wherein the bi-level decentralized ML model comprises a temporal graph-based ML model that includes an execution flow of the program code and combines knowledge from a plurality of cells in the communication network that respectively execute the program code; and
based on the evaluation, identify an anomaly in the communication network.

20. (canceled)

21. (canceled)

22. (canceled)
